(19) United States
(12) Patent Application Publication
(10) Pub. No.: US 2013/0222121 A1
(43) Pub. Date: Aug. 29, 2013

(54) REMOTE CONTROL SYSTEM CAPABLE OF BIDIRECTIONALLY EXCHANGING DATA BY SIGNAL LINE AND METHOD THEREOF

(71) Applicant: Chih-Yuan SHEN, New Taipei City (TW)

(72) Inventor: Chih-Yuan SHEN, New Taipei City (TW)

(21) Appl. No.: 13/404,650

(22) Filed: Feb. 24, 2012

(51) Int. Cl. G05B 11/01

(52) U.S. Cl. 340/12.22

(57) ABSTRACT

The present invention discloses a remote control system capable of bidirectionally exchanging data by a signal line and a method thereof. The system comprises a remote control device and a remote control receiver. The remote control receiver comprises a first frontend circuit. The remote control device comprises a second frontend circuit. The second frontend circuit transmits a handshake signal to the first frontend circuit after receiving a PPM signal. The first frontend circuit transmits a reply signal to the second frontend circuit in response to the handshake signal. The second frontend circuit transmits an acknowledge signal to the first frontend circuit in response to the reply signal. After receiving the acknowledge signal, the first frontend circuit transmits a formatted packet including the PPM signal to the second frontend circuit to control and set the hardware, and then the second frontend circuit sends feedback data to a remote control transmitter.

### BACKGROUND OF THE INVENTION

1. Field of the Invention

The present invention generally relates to a remote control system, in particular to a remote control system capable of bidirectionally exchanging data by a signal line and a method thereof.

2. Description of the Related Art

A conventional remote control receiver receives RF signals broadcast by a remote control transmitter in order to control a remote control device. As shown in FIG. 1, the conventional remote control receiver 11 receives RF signals from a remote control transmitter by the RF unit 111. The RF signals are transmitted to the PPM generator 113 via the receiver main unit 112 and translated into PPM signals. The PPM signals will be dispatched to corresponding channels by the receiver socket, which usually formed by 3-pin headers. As shown in FIG. 2, a user can connect the desired remote control device 12 to the remote control receiver 11 by plugging the device's receiver cable to the receiver socket. The remote control device 12 acquires PPM signals from the receiver cable and transmits the PPM signals via the PPM input unit interface 121 and the device control unit 122 in order to control its hardware 123 to achieve reasonable actions, for example, servo horn position as a servo, throttle position as an electronic speed controller, or tail angular velocity as a Gyro, etc.

However, there is only one signal line on each receiver cable for remote control receiver 11 to send PPM signals to device. The PPM signal can only carry very simple information, and it's not suitable to bring complex data. Therefore, the conventional remote control receiver 11 provides one way control only, and the conventional remote control device 12 cannot feedback any data to the remote control receiver 11 by the receiver cable.

As shown in FIG. 3, another conventional remote control receiver 31 can gather feedback information from the remote control device by a dedicated data port 312 and send back the feedback information to the remote control transmitter. If any remote control device needs to feedback data to the remote control receiver 31, it must append an extra cable to connect to the dedicated data port, which causes inconvenience to the user. Accordingly, it is the primary object of the present invention to provide a remote control system capable of bidirectionally exchanging data by a single line without any extra component.

### SUMMARY OF THE INVENTION

Therefore, it is a primary objective of the present invention to provide a remote control system capable of bidirectionally exchanging data by a single line without any extra component in order to resolve the problems of the convention remote control system.

To achieve the foregoing objective, the present invention provides a remote control system capable of bidirectionally exchanging data by a signal line. The system comprises a remote control device and a remote control receiver. The remote control receiver comprises a radio frequency (RF) unit, a first core unit, and a first frontend circuit. The remote control device is connected to the remote control receiver and comprises a second frontend circuit, a second core unit, and hardware. The RF unit transmits a RF signal received from a remote control transmitter to the first frontend circuit via the first core unit to generate a pulse position modulation (PPM) signal. The second frontend circuit receives the PPM signal from the first frontend circuit and transmits a handshake signal to the first frontend circuit in response to the PPM signal; and then the first frontend circuit transmits a reply signal to the second frontend circuit in response to the handshake signal. The second frontend circuit transmits an acknowledge signal to the first frontend circuit in response to the reply signal. After the first frontend circuit receives the acknowledge signal, partial channels connected to the remote control device switches to data exchange mode, and the first frontend circuit encloses setting data and the PPM signal into a formatted packet and transmits which to the second frontend circuit. The second frontend circuit unpacks the formatted packet to obtain the setting data and the PPM signal and transmits which to the hardware via the second core unit so as to control and set the hardware.

To achieve the foregoing objective, the present invention further provides a single line data exchange method. The method comprises the following steps of: transmitting a RF signal received from a remote control transmitter to a first frontend circuit via a first core unit by a RF unit in order to generate a PPM signal; receiving the PPM signal and transmitting a handshake signal by a second frontend circuit to the first frontend circuit in response to the PPM signal; transmitting a reply signal to the second frontend circuit by the first frontend circuit in response to the handshake signal; transmitting an acknowledge signal to the first frontend circuit by the second frontend circuit in response to the reply signal; receiving the acknowledge signal and switching partial channels connected to the remote control device to data exchange mode by the first frontend circuit; enclosing setting data and the PPM signal into a formatted packet and transmitting which to the second frontend circuit by the first frontend circuit; and unpacking the formatted packet to obtain the setting data and the PPM signal and transmitting which to the hardware via the second core unit by the second frontend circuit so as to control and set the hardware.

In a preferred embodiment of the present invention, the second frontend circuit may enclose feedback data into a response packet and transmits the response packet to the first frontend circuit after receiving the formatted packet.

In a preferred embodiment of the present invention, the first frontend circuit may unpack the response packet to obtain the feedback data after receiving the response packet; and the first core unit gathers the feedback data and sends back the feedback data to the transmitter by the RF unit.

In a preferred embodiment of the present invention, the feedback data may comprise packets containing information related to the remote control device.

In a preferred embodiment of the present invention, the information related may comprise one or more parameters of temperature, voltage, current and battery residual capacity.

In a preferred embodiment of the present invention, the setting data may comprise packets containing information related to the remote control device.

In a preferred embodiment of the present invention, the information to the remote control device may comprise one or more parameters of throttle ratio, acceleration curve, battery protection voltage and a device protection temperature.

The remote control system capable of bidirectionally exchanging data by a single line and the method thereof according to the present invention have the following advantages:

(1) The remote control system according to the present invention applies frontend circuits on both remote control receiver and device, which has ability to handle digital data packet and PPM signal, and determine which format to use. Accordingly, the user can set the remote control device by sending a setting signal and acquire feedback information from the remote control device.

(2) The remote control system according to the present invention can bidirectionally exchange data without any extra component, which is more convenient to the user.

(3) The remote control receiver and device according to the present invention can work fine as respectively connected to a convention remote control device and receiver. Thus, the present invention extends flexibility of the remote control system.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a block diagram of a convention remote control receiver.

FIG. 2 is a block diagram of a convention remote control device.

FIG. 3 is a block diagram of another convention remote control receiver.

FIG. 4 is a block diagram of a first preferred embodiment of the remote control system in accordance with the present invention.

FIG. 5 is a flow chart of a first preferred embodiment of the remote control system in accordance with the present invention.

FIG. 6A is a block diagram of a second preferred embodiment of the remote control receiver in accordance with the present invention.

FIG. 6B is a block diagram of a second preferred embodiment of the remote control device in accordance with the present invention.

FIGS. 7A and 7B are schematic views of a third preferred embodiment of the remote control system in accordance with the present invention.

FIG. 8 is a flow chart of the single line data exchange method in accordance with the present invention.

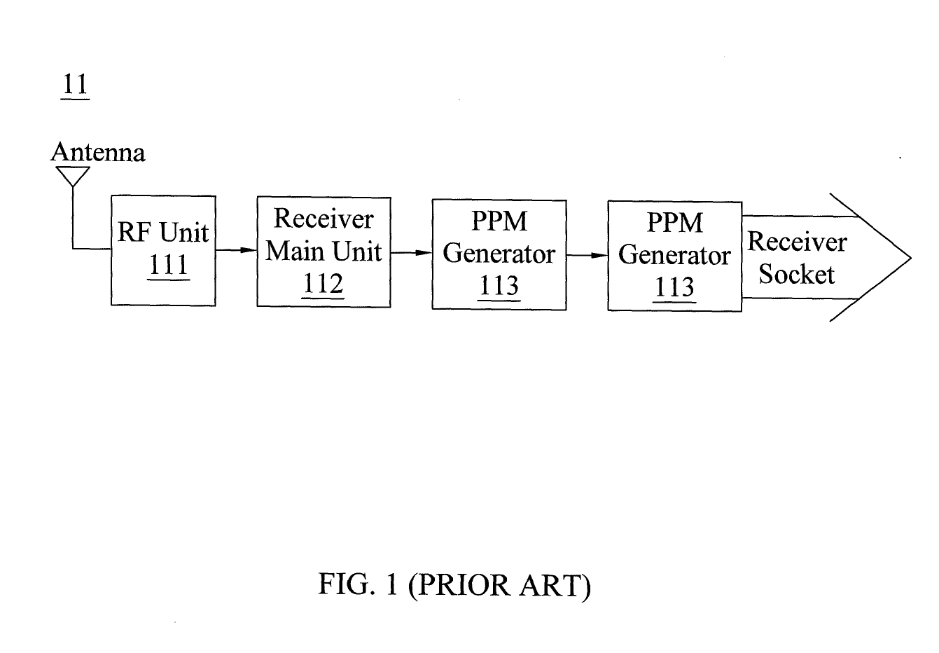

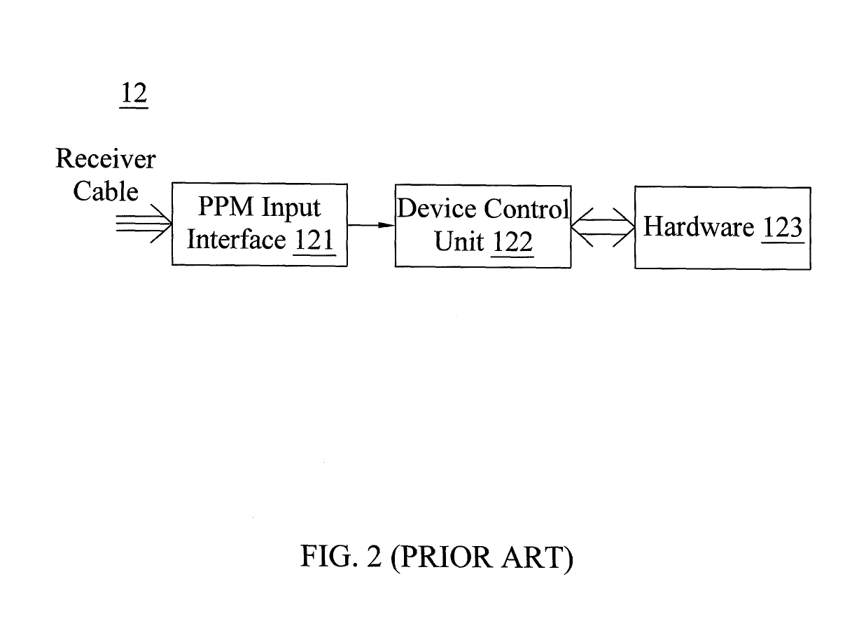

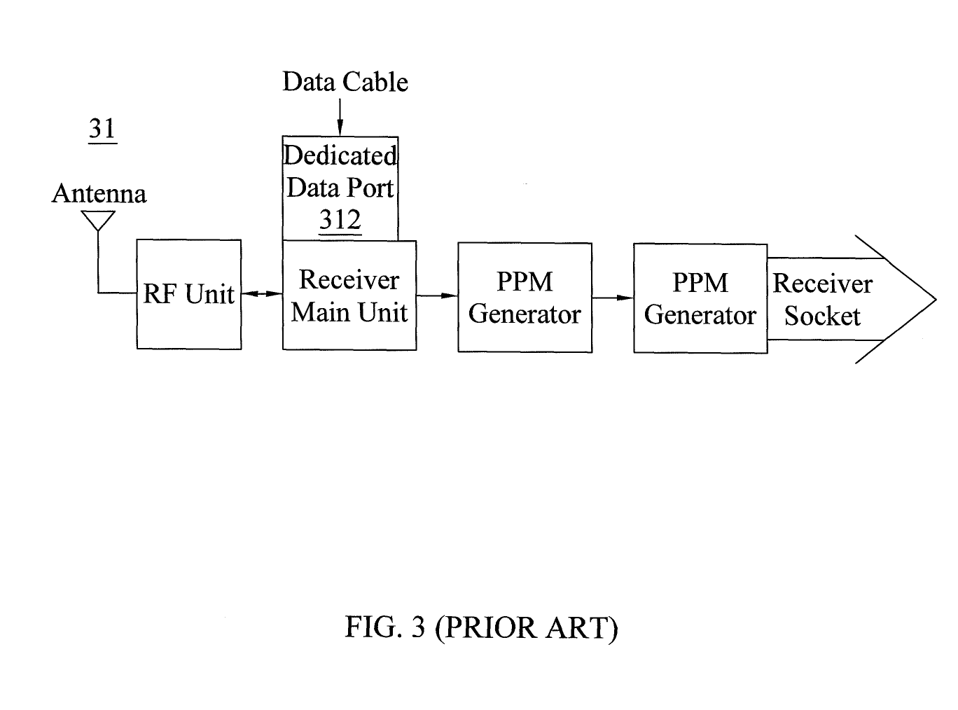

### DETAILED DESCRIPTION OF THE PREFERRED EMBODIMENTS

The technical content of the present invention will become apparent by the detailed description of the following embodiments and the illustration of related drawings as follows. All illustrated diagrams are functional block to explain how the remote control system according to the present invention works. The implementation of the remote control system according to the present invention is not restricted in particular circuits or layout, which may be separate parts or integrated circuit to match demand of design.

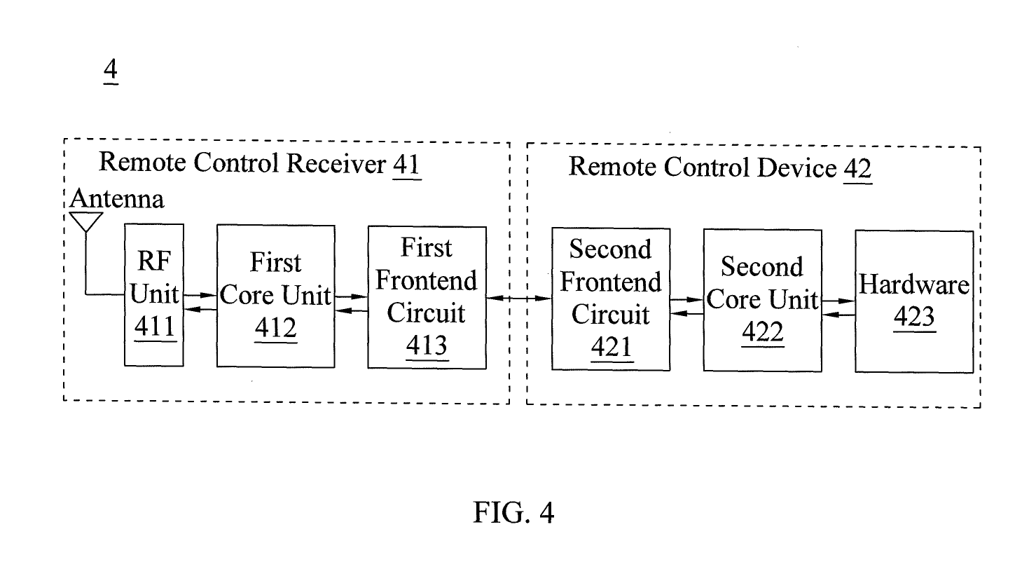

With reference to FIG. 4 for a block diagram of a first preferred embodiment of the remote control system in accordance with the present invention. The remote control system 4 comprises the remote control receiver 41 and the remote control device 42. The remote control receiver 41 comprises the radio frequency (RF) unit 411, the first core unit 412 and the first frontend circuit 413. The remote control device 42 is connected to the remote control receiver 41, and comprises a second frontend circuit 421, the second core unit 422 and the hardware 423.

The RF unit 411 receives a RF signal form a remote control transmitter and transmits which to the first core unit 412. The RF signal is processed by the first core unit 412 and transmitted to the first frontend circuit 413 in order to generate a PPM signal. When receiving the pulse position modulation (PPM) signal from the first frontend circuit 413, the second frontend circuit 421 will initiate a handshake procedure and transmit a handshake signal to the first frontend circuit 413 in responses to the PPM signal. After receiving the handshake signal, the first frontend circuit 413 transmits a reply signal to the second frontend circuit 421 in response to the handshake signal. On receiving the reply signal, the second frontend circuit 421 transmits an acknowledge signal to the first frontend circuit 413 in response to the reply signal. After the first frontend circuit 413 receives the acknowledge signal, partial channels connected to the remote control device 42 will switch to data exchange mode, and the first frontend circuit 413 encloses setting data and the PPM signal into a formatted packet and transmits which to the second frontend circuit 421. The second frontend circuit 421 will unpack the formatted packet to obtain the setting data and original PPM signal and transmits which to the hardware 423 via the second core unit 422 so as to control and set the hardware 423.

During the data exchange mode, the user can transmit the setting data to the remote control receiver 41 to set the hardware 423. For example, the user may modify the throttle ratio, the acceleration curve, the battery protection voltage and the battery temperature voltage of the remote control device 42.

In an embodiment, the setting data may comprise packets containing information related to the remote control device 42. The information to the remote control device 42 may comprise one or more parameters of throttle ratio, acceleration curve, battery protection voltage, a device protection temperature and other information related to the remote control device 42.

Moreover, after receiving the formatted packet, the second frontend circuit 421 encloses feedback data into a response packet and transmits the response packet to the first frontend circuit 413. The first frontend circuit 413 unpacks the response packet to obtain the feedback data after receiving the response packet; and the first core unit 412 gathers the feedback data and sends back the feedback data to the remote control transmitter by the RF unit 411. In an embodiment, the feedback data may comprise packets containing information related to the remote control device 42. The information related to the remote control device 42 may comprise one or more parameters of temperature, voltage, current, battery residual capacity and other information related to the remote control device 42.

It is worthy to point out that the remote control system applies frontend circuits on both remote control receiver and devices, which can handle digital data packet and PPM signal, and determine which format to use. Accordingly, remote control devices can feedback information to remote control receiver, and then remote control receiver can send information back to remote control transmitter for the user. In addition, the user can also send extra data more than pure PPM signal to remote control devices for detail configuration. For example, the user may change servo's response, torque and boundary on the transmitter without any extra setting tool.

Due to forward compatibility of PPM signal, when a conventional remote control device is connected to the remote control receiver according to the present invention, the receiver will determine and set the particular channel to normal mode. There will be PPM signal only on the channel, so the conventional remote control device can work fine as connected to a conventional remote control receiver. Similarly, when the remote control device according to the present invention is connected to a conventional remote control receiver, the device can handle PPM signal as well, and works like a conventional remote control device. Accordingly, with the single line data exchange ability and forward compatibility to PPM signal, the remote control system according to the present invention can extend flexibility of the remote control system.

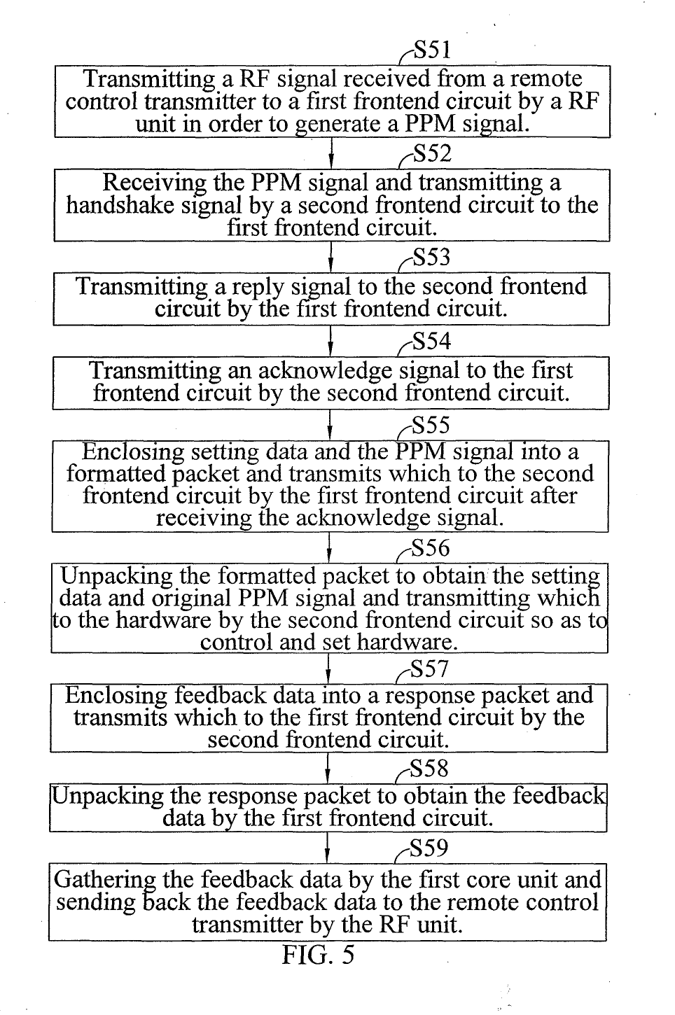

With reference to FIG. 5 for a flow chart of a first preferred embodiment of the remote control system in accordance with the present invention. The embodiment comprises the following steps of:

S51: Transmitting a RF signal received from a remote control transmitter to a first frontend circuit by a RF unit in order to generate a PPM signal.

S52: Receiving the PPM signal and transmitting a handshake signal by a second frontend circuit to the first frontend circuit.

S53: Transmitting a reply signal to the second frontend circuit by the first frontend circuit.

S54: Transmitting an acknowledge signal to the first frontend circuit by the second frontend circuit.

S55: Enclosing setting data and the PPM signal into a formatted packet and transmits which to the second frontend circuit by the first frontend circuit after receiving the acknowledge signal.

S56: Unpacking the formatted packet to obtain the setting data and original PPM signal and transmitting which to the hardware by the second frontend circuit so as to control and set hardware.

S57: Enclosing feedback data into a response packet and transmits which to the first frontend circuit by the second frontend circuit.

S58: Unpacking the response packet to obtain the feedback data by the first frontend circuit.

S59: Gathering the feedback data by the first core unit and sending back the feedback data to the remote control transmitter by the RF unit.

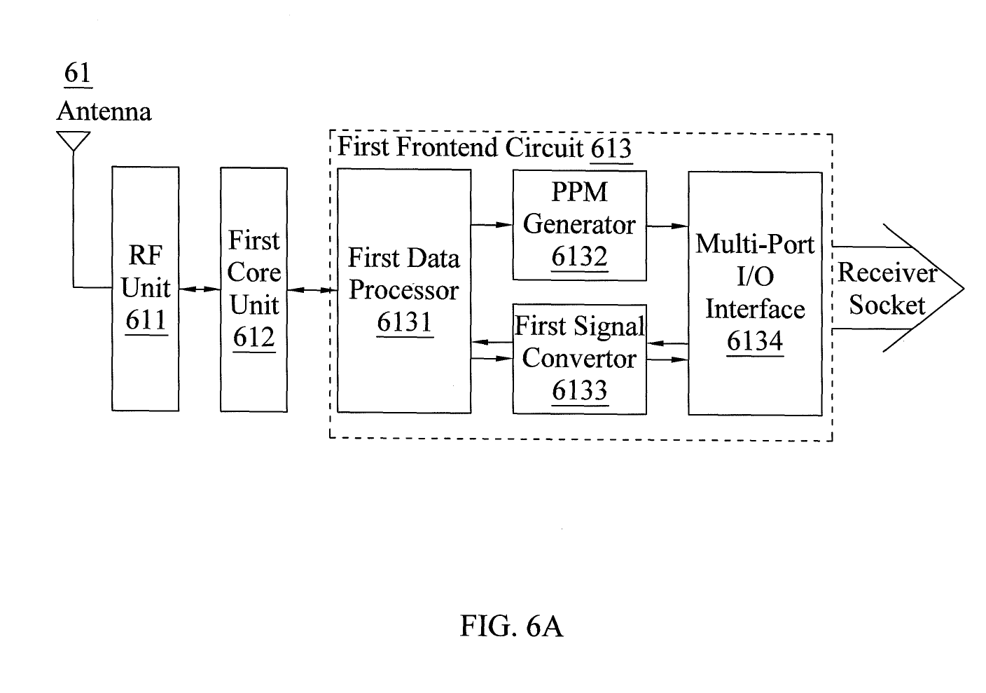

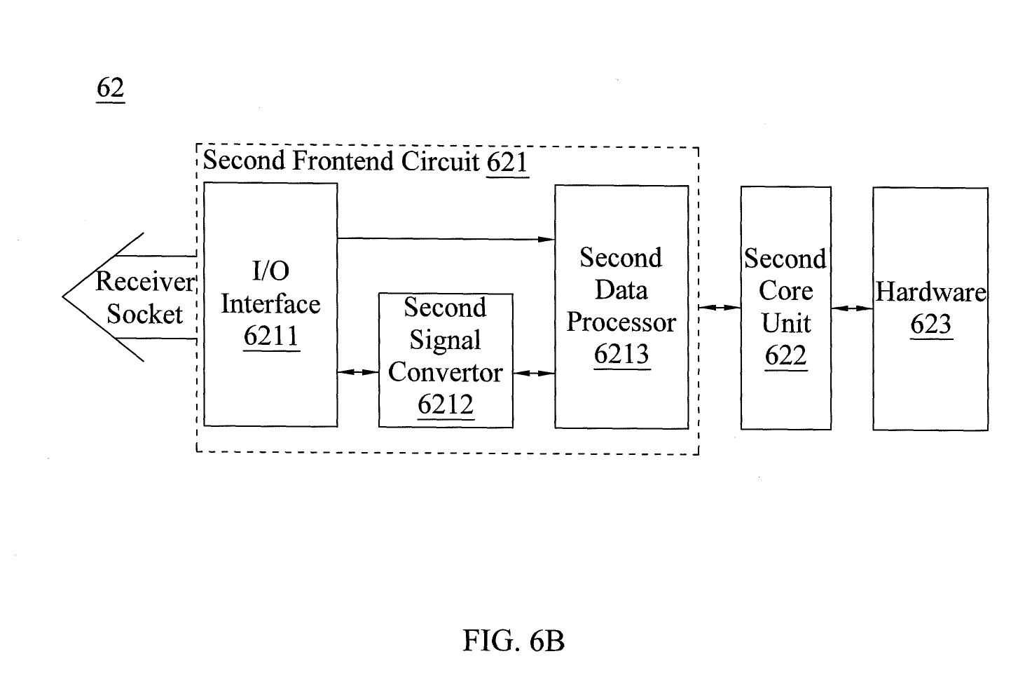

Please refer to FIGS. 6A and 6B. FIG. 6A is a block diagram of a second preferred embodiment of the remote control receiver in accordance with the present invention.

FIG. 6B is a block diagram of a second preferred embodiment of the remote control device in accordance with the present invention. As shown in FIG. 6A, the remote control receiver 61 comprises the RF unit 611, the first core unit 612, and the first frontend circuit 613. The first frontend circuit 613 comprises the first data processor 6131, the PPM generator 6132, the first signal converter 6133 and the multi-port I/O interface 6134. As shown in FIG. 6B, the remote control device 62 comprises the second frontend circuit 621, the second core unit 622, and the hardware 623. The second frontend circuit 621 comprises the I/O interface 6211, the second signal converter 6212 and the second data processor 6213. When the remote control receiver 61 is powered up, every channel works in normal mode. The first core unit 612 receives a RF signal from a remote control transmitter by the RF unit 611. The RF signal is transmitted to the first data processor 6131 via the first core unit 612. The first data processor 6131 decodes data in order to generate a PPM signal through the PPM generator 6132. Then, the PPM signal will be dispatched to each channel from the multi-port I/O interface 6134. A conventional remote control device can be connected to the remote control receiver 61 and work as normal without any extra setting and modification. Meanwhile, the remote control receiver 61 works like a conventional remote control receiver.

When the remote control device 62 is powered up, it waits for signals from the receiver cable by the I/O interface 6211. Once the PPM signal is received, the second data processor 6213 will launch a handshake procedure to determine the availability of the remote control receiver 61. When the remote control device 62 starts a handshake procedure, the second data processor 6213 will send a series of specific signal patterns as a handshake signal through the I/O interface 6211 by the second signal converter 6212, and then waits for response from the remote control receiver 61.

If the remote control device 62 is connected to a conventional remote control receiver, there will no valid handshake response, and then the remote control device 62 will work in normal mode. The PPM signal from the conventional remote control receiver will go through the I/O interface 6211 to the second data processor 6213, and the second core unit 622 will interpret which to control the hardware 623. When the remote control device 62 is switched to normal mode, it works like a conventional remote control device.

If the remote control device 62 is connected to the remote control receiver 61, the receiver 61 will identify handshake signals and reply. The first data processor 6131 of the receiver 61 will send back a specific formatted data packet as a reply signal by the first signal converter, and pass it to through the multi-port I/O interface 6134 to partial channel connected to the remote control device 62 and wait for an acknowledge signal.

When the remote control device receives the handshake reply, the second data processor 6213 will send back a specific acknowledge packet to the receiver 61 and then the handshake procedure is completed. The remote control device 62 will now work in data exchange mode.

When the remote control device 62 got the acknowledgement, the partial channel connected to the remote control device 62 will switch to data exchange mode, the first data processor 6131 will enclose all data into a formatted packet, including original PPM signal, and send the formatted packet to the remote control device 62.

When the remote control device 62 got the formatted packet, the second data processor 6213 will unpack the formatted packet to obtain original PPM signal and other data, and then generate a response packet with all feedback data.

When the remote control receiver 61 got the response packet, the first data processor 6131 will unpack the response packet and determine if there is any feedback data and then the first core unit 612 will gather the feedback data and send back all feedback data to the remote control transmitter by the RF unit 611.

In addition, the first data processor 6131 of the remote control receiver 61 uses the response packet to check the availability of the remote control device 62, too. If the first data processor 6131 fails to obtain valid response packet after the data packet is send, the data exchange transaction will fail, and then the partial channels connected to the remote control device 62 will switch back to normal mode until next successful handshake procedure.

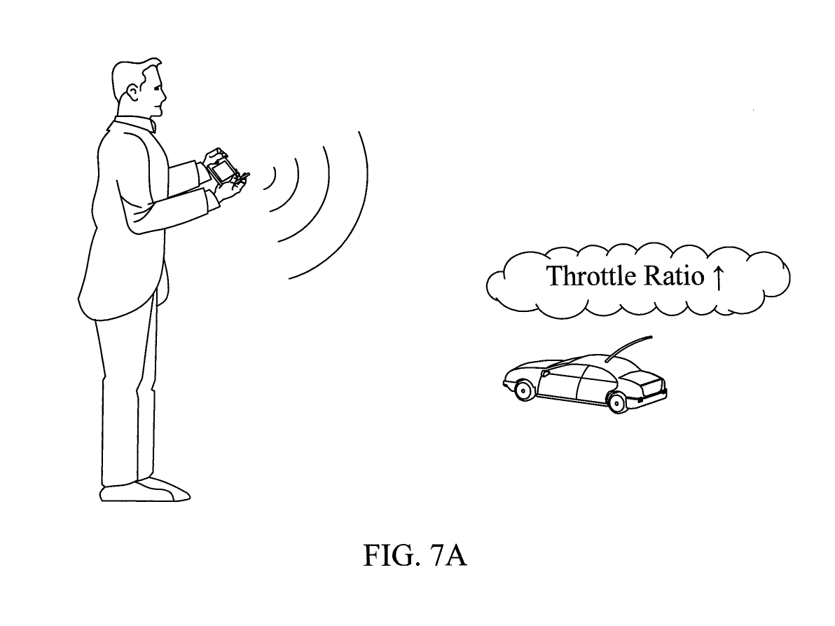

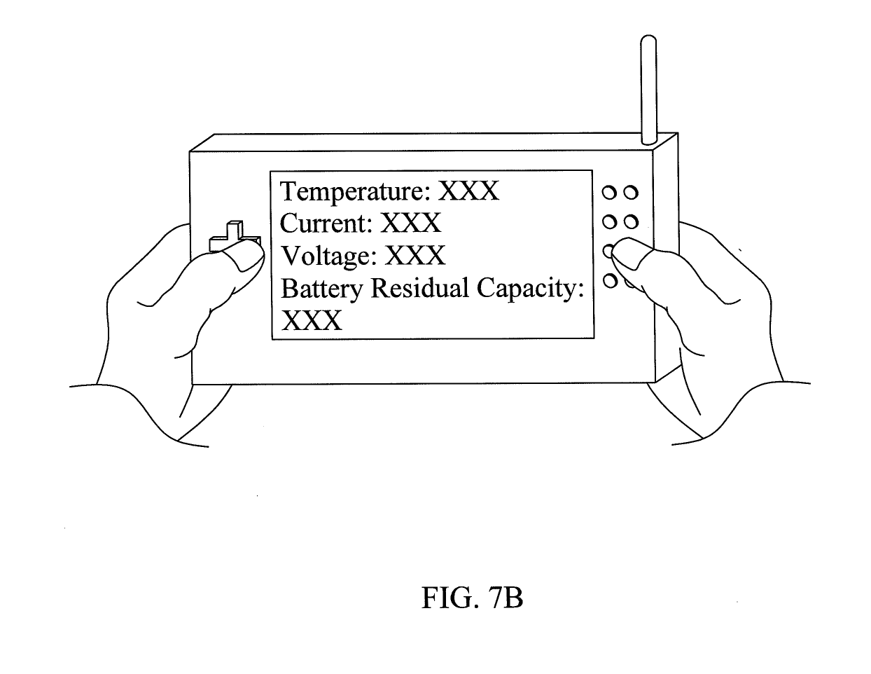

With reference to FIGS. 7A and 7B for schematic views of a third preferred embodiment of the remote control system in accordance with the present invention. As shown in FIG. 7A, the user uses a remote control transmitter to control the remote control car. Due to the bidirectional data exchange function, the user can transmit a setting signal to adjust the full throttle ratio of the remote control car. As shown in FIG. 7B, the remote control car can also send feedback data to the remote control transmitter and then the user can check the feedback data via the display of the remote control transmitter.

Even though the concept of the single line data exchange method in accordance with the present invention has been described in the aforementioned process of the remote control system capable of bidirectionally exchanging data by a signal line in accordance with the present invention, yet a flow chart is provided for further illustrating the present invention as follows.

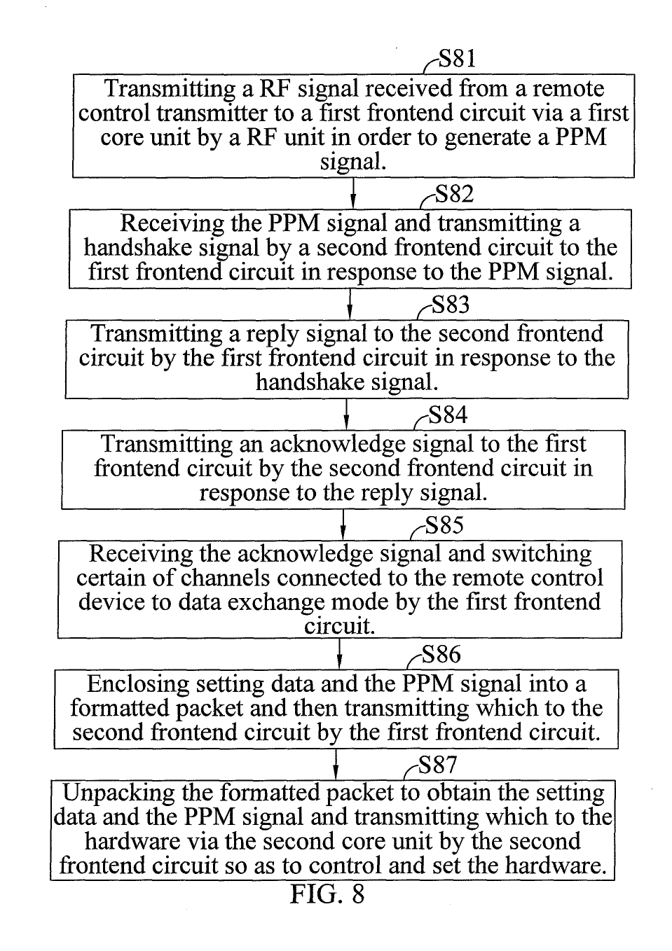

With reference to FIG. 8 for a flow chart of the single line data exchange method in accordance with the present invention. The method comprises the following steps of:

S81: Transmitting a RF signal received from a remote control transmitter to a first frontend circuit via a first core unit by a RF unit in order to generate a PPM signal.

S82: Receiving the PPM signal and transmitting a handshake signal by a second frontend circuit to the first frontend circuit in response to the PPM signal.

S83: Transmitting a reply signal to the second frontend circuit by the first frontend circuit in response to the handshake signal.

S84: Transmitting an acknowledge signal to the first frontend circuit by the second frontend circuit in response to the reply signal.

S85: Receiving the acknowledge signal and switching certain of channels connected to the remote control device to data exchange mode by the first frontend circuit.

S86: Enclosing setting data and the PPM signal into a formatted packet and then transmitting which to the second frontend circuit by the first frontend circuit.

S87: Unpacking the formatted packet to obtain the setting data and the PPM signal and transmitting which to the hardware via the second core unit by the second frontend circuit so as to control and set the hardware.

The detailed description and implementation method of the single line data exchange method in accordance with the present invention have been described in the section of the remote control system capable of bidirectionally exchanging data by a signal line in accordance with the present invention already, and thus will not be repeated.

In summation of the description above, the remote control system according to the present invention applies frontend circuits on both remote control receiver and device, which has ability to handle digital data packet and PPM signal, and determine which format to use. Accordingly, the user can set the remote control device by sending a setting signal and acquire feedback information from the remote control device. Besides, the remote control system according to the present invention can bidirectionally exchange data without extra setting tools or additional cables, which is more convenient to the user. Moreover, the remote control receiver and device according to the present invention can work fine as respectively connected to a convention remote control device and receiver. Thus, the present invention extends flexibility of the remote control system.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A remote control system capable of bidirectionally exchanging data by a signal line, comprising:
a remote control receiver, comprising a radio frequency (RF) unit, a first core unit, and a first frontend circuit;
a remote control device, connected to the remote control receiver, comprising a second frontend circuit, a second core unit, and hardware; and
wherein, the RF unit transmits a RF signal received from a remote control transmitter to the first frontend circuit via the first core unit to generate a pulse position modulation (PPM) signal; the second frontend circuit receives the PPM signal from the first frontend circuit and transmits a handshake signal to the first frontend circuit in response to the PPM signal; and the first frontend circuit transmits a reply signal to the second frontend circuit in response to the handshake signal; the second frontend circuit transmits an acknowledge signal to the first frontend circuit in response to the reply signal; after the first frontend circuit receives the acknowledge signal, partial channels connected to the remote control device switches to data exchange mode, and the first frontend circuit encloses setting data and the PPM signal into a formatted packet and transmits the formatted packet to the second frontend circuit; the second frontend circuit unpacks the formatted packet to obtain the setting data and the PPM signal to transmit the setting data and the PPM signal to the hardware via the second core unit so as to control and set the hardware.

2. The remote control system of claim 1, wherein the second frontend circuit encloses feedback data into a response packet and transmits the response packet to the first frontend circuit after receiving the formatted packet.

3. The remote control system of claim 2, wherein the first frontend circuit unpacks the response packet to obtain the feedback data after receiving the response packet; and the first core unit gathers the feedback data and sends back the feedback data to the remote control transmitter by the RF unit.

4. The remote control system of claim 2, wherein the feedback data comprises packets containing information related to the remote control device.

5. The remote control system of claim 4, wherein the information related to the remote control device comprises one or more parameters of temperature, voltage, current and battery residual capacity.

6. The remote control system of claim 1, wherein the setting data comprises packets containing information related to the remote control device.

7. The remote control system of claim 6, wherein the information to the remote control device comprises one or more parameters of throttle ratio, acceleration curve, battery protection voltage and a device protection temperature.

8. A single line data exchange method, comprising the following steps of:
transmitting a RF signal received from a remote control transmitter to a first frontend circuit via a first core unit by a RF unit in order to generate a PPM signal;
receiving the PPM signal and transmitting a handshake signal to the first frontend circuit by a second frontend circuit in response to the PPM signal;
transmitting a reply signal to the second frontend circuit by the first frontend circuit in response to the handshake signal;
transmitting an acknowledge signal to the first frontend circuit by the second frontend circuit in response to the reply signal;
receiving the acknowledge signal and switching partial channels connected to the remote control device to data exchange mode by the first frontend circuit;
enclosing setting data and the PPM signal into a formatted packet and transmitting the formatted packet to the second frontend circuit by the first frontend circuit; and
unpacking the formatted packet to obtain the setting data and the PPM signal to transmit the setting data and the PPM signal to the hardware via the second core unit by the second frontend circuit so as to control and set the hardware.

9. The method of claim 8, further comprising the following step of:
enclosing feedback data into a response packet and transmitting the response packet to the first frontend circuit by the second frontend circuit after receiving the formatted packet.

10. The method of claim 9, further comprising the following steps of:
unpacking the response packet to obtain the feedback data by the first frontend circuit after receiving the response packet; and
gathering the feedback data by the first core unit and sending back the feedback data to the remote control transmitter by the RF unit.

11. The method of claim 9, wherein the feedback data comprises packets containing information related to the remote control device.

12. The method of claim 11, wherein the information related to the remote control device comprises one or more parameters of temperature, voltage, current and battery residual capacity.

13. The method of claim 8, wherein the setting data comprises packets containing information related to the remote control device.

14. The method of claim 13, wherein the information related to the remote control device comprises one or more parameters of throttle ratio, acceleration curve, battery protection voltage and a device protection temperature.
